(19) United States
(12) Patent Application Publication
(10) Pub. No.: US 2019/0179773 A1
(43) Pub. Date: Jun. 13, 2019

(54) METHOD FOR WRITING A SET OF INFORMATION ENCRYPTED IN AN EXTERNAL MEMORY OF AN INTEGRATED CIRCUIT AND CORRESPONDING INTEGRATED CIRCUIT

(71) Applicant: STMicroelectronics (Grenoble 2) SAS, Grenoble (FR)

(72) Inventors: Dragos Davidescu, Lambesc (FR); Nicolas Anquet, Grenoble (FR)

(73) Assignee: STMicroelectronics (Grenoble 2) SAS, Grenoble (FR)

(21) Appl. No.: 16/207,817

(22) Filed: Dec. 3, 2018

(30) Foreign Application Priority Data
Dec. 11, 2017 (FR) 1761921

(51) Int. Cl. G06F 12/14; H04L 9/08; H04L 9/16; G06F 21/72

(52) U.S. Cl. CPC G06F 12/1408; H04L 9/0861; G06F 2212/1052; H04L 9/0894; G06F 21/72; H04L 9/16

(57) ABSTRACT

A method for writing a set of information for processing by a processing unit of an integrated circuit in an external memory outside the integrated circuit, includes: generating, within the integrated circuit, an encryption key; for each item of information intended to be written at an address of the external memory, first encrypting the address within the integrated circuit by a first encryption/decryption circuit using the encryption key to obtain an encrypted address; second encrypting the item of information within the integrated circuit using a second encryption/decryption circuit using the encrypted address to obtain an encrypted item of information; and writing the encrypted item of information at the address of the external memory, wherein the external memory is not able to be written twice at a same address during a write process

### CROSS-REFERENCE TO RELATED APPLICATIONS

This application claims the benefit of French Application No. 1761921, filed on Dec. 11, 2017, which application is hereby incorporated herein by reference.

### TECHNICAL FIELD

This disclosure relates generally to the encryption and decryption of information, and in particular embodiments to a method for writing a set of information (for example, a program code) encrypted in an external memory of an integrated circuit and a corresponding integrated circuit.

### BACKGROUND

Storing an encrypted program code in an external memory outside the integrated circuit containing the processing unit makes the encryption and storage process more vulnerable to fault injection attacks attempting, in particular, to retrieve the encryption key.

There is therefore a need to make such an encryption and storage process more robust in the face of such attacks.

Furthermore, it is desirable for the increase in robustness to be compatible with a low latency of the encryption process, above all when this process is performed on the fly.

### SUMMARY

According to an embodiment, provision is made for meeting this need for robustness while providing low latency.

According to one aspect, a method for writing information, in particular on the fly, is therefore provided, this information being for example a program code intended to be run by a processing unit of an integrated circuit, for example a microcontroller, the write operation being performed in an external memory outside the integrated circuit.

The method includes, before starting the process of writing the information, generating, within the integrated circuit, an encryption key, for example, but non-limitingly, randomly.

The method also includes, during the write process, for each item of information, for example a code datum, intended to be written at an address of the memory, a first operation of encrypting the address within the integrated circuit by a first encryption/decryption circuit, for example a circuit executing a symmetric encryption algorithm of AES type, using the key to obtain an encrypted analysis.

The method also includes a second operation of encrypting the item of information within the integrated circuit using a second encryption/decryption circuit using the encrypted address, and an operation of writing the encrypted item of information at the address, the memory not being able to be written twice at the same address during the write process.

Thus, by preventing, during the process of writing the information, for example the program code, the memory from being written twice at the same address, a malicious third party is prevented from modifying the write process to write multiple different data in succession at the same address with a view to obtaining the encryption key.

It is thus possible to write a robustly encrypted set of information, for example a program code, on the fly, this operation of generating addresses configured so that the memory cannot be written twice at the same address during the write process having a very small or even no impact on the latency of the write process.

One particularly simple way of preventing the memory from being written twice at the same address during the write process includes writing the first item of information at an initial address then incrementing the address after each operation of writing a datum.

However, writing the memory in a strictly incremental mode is only one non-limiting example.

It would be entirely possible for example to provide a table storing the successive addresses used and a circuit checking, before addressing the memory at a current address, that this address is not already in the table.

Furthermore, when the set of information, for example the program code, is intended to be written in a range of addresses of the memory, it is particularly advantageous, once all of the addresses of the range have been used in the write process, to forbid any new operation of writing in the memory using the encryption key that was just used.

Besides the fact that the encryption key may advantageously be randomly generated, it is preferable, still with a view to increasing the robustness of the process of writing the set of information, for example the program code, to generate a new encryption key before each new write process, for example when the program code is to be modified or updated.

The external memory may be a volatile memory or a non-volatile memory, for example a flash memory.

Furthermore, it is advantageous, with a view to decrypting the set of information, for example the memory code, to store the encryption key in an internal storage inside the integrated circuit, for example in a protected memory.

According to another aspect, a method is provided for processing a set of information, in particular on the fly, for example a method for running a program code, by a processing unit of an integrated circuit, the set of information, for example the code data of the program code, having been written in an external memory outside the integrated circuit according to the method such as defined above.

The processing method then includes, for each item of information stored at an address of the external memory and intended to be loaded into the processing unit, a first operation of encrypting the address within the integrated circuit by a first encryption/decryption circuit using the key to obtain an encrypted address, an operation of reading the encrypted item of information stored in the external memory at the address, an operation of decrypting the encrypted item of information within the integrated circuit using the second encryption/decryption circuit using the encrypted address, and an operation of loading the decrypted datum into a register of the processing unit. This register may be a data register if the items of information are data or else an instruction register if the items of information are instructions or code data of a program code.

According to another aspect, a device is provided including an integrated circuit including a processing unit and an external memory outside the integrated circuit, the integrated circuit including an information input for receiving a set of information, for example a program code, intended to be written in the external memory with a view to its later processing, for example its running, by the processing unit, a generation circuit configured to generate an encryption key, an addressing circuit configured to generate an address of the memory for each item of information intended to be written in the memory and not to generate the same address twice in the process of writing the program code, a first encryption/decryption circuit configured to perform a first operation of encrypting the address using the key to obtain an encrypted address, a second encryption/decryption circuit configured to perform a second operation of encrypting the item of information using the encrypted address, and a write circuit configured to write the encrypted item of information at the address.

According to one embodiment, during the write process, the addressing circuit is configured to generate an initial address and to increment the address after each operation of writing an item of information.

According to one embodiment, the addressing circuit is configured to write the set of information in a range of addresses of the memory, and to prevent any new addressing once all of the addresses of the range have been used in the write process.

According to one embodiment, the generating circuit is configured to generate the encryption key in a random manner.

According to one embodiment, the generation circuit is configured to generate a new encryption key before each new write process.

According to one embodiment, the second encryption/decryption circuit includes an EXCLUSIVE OR operator.

According to one embodiment, the second encryption/decryption circuit includes a scrambling circuit configured to modify the inputs of the EXCLUSIVE OR operator according to a scrambling code.

According to one embodiment, the device further includes an internal storage (e.g. a protected memory) inside the integrated circuit configured to store the encryption key.

According to one embodiment, when the external memory contains items of information, for example encrypted code data, the first encryption/decryption circuit is configured to extract the encryption key from the internal storage and to encrypt, using the encryption key, each address at which an item of information is to be read, the integrated circuit including a read circuit configured to read, in the external memory at the address, the encrypted item of information, and the second encryption/decryption circuit is configured to decrypt the read encrypted item of information with the encrypted address, and to deliver the decrypted item of information to an instruction register of the processing unit.

### BRIEF DESCRIPTION OF THE DRAWINGS

Other advantages and features of the invention will become apparent on examining the detailed description of wholly non-limiting modes of implementation and embodiments and the appended drawings, in which:

FIGS. 1 to 6 schematically illustrate implementations and embodiments of the invention.

### DETAILED DESCRIPTION OF ILLUSTRATIVE EMBODIMENTS

Throughout what follows, it is assumed by way of non-limiting example that the set of information intended to be stored encrypted in an external memory is a program code, although this information may also be data.

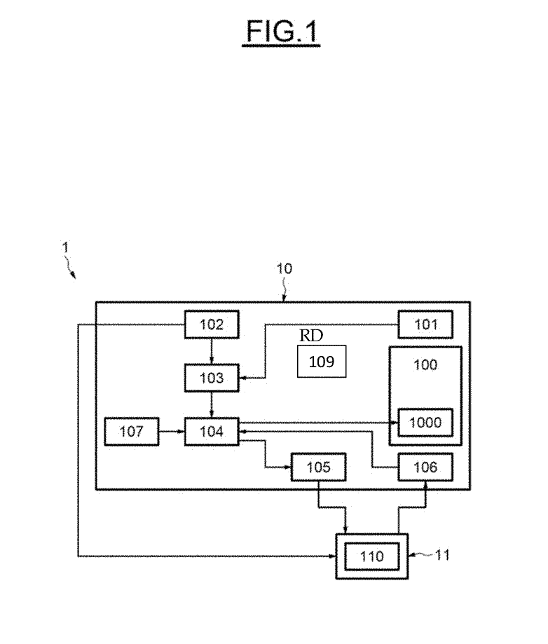

In FIG. 1, the reference 1 denotes a device including an integrated circuit 10 and a memory 11, external to the integrated circuit 10.

The memory 11 is intended to store an encrypted program code 110 intended to be run by a processing unit 100 of the integrated circuit. This processing unit may for example be a microcontroller such as a microcontroller of the STM32® family marketed by STMicroelectronics.

The external memory 11 may be a random-access memory or else a read-only memory, for example a flash memory.

The integrated circuit 10 includes a code input 107 for receiving a program code intended to be written encrypted in the external memory 11.

The device 1 also includes, within the integrated circuit 10, a generation circuit 101 configured to generate an encryption key. This encryption key RD may be generated randomly at the start of the process of writing the program code. In this case, preferably, any time a process of writing a program code is repeated, for example when modifying or updating the program code, it is advantageously possible to generate a new encryption key, valid for the write process currently in progress.

Such generation circuit 101 is conventional in structure and known structures in the art.

The integrated circuit 10 also includes addressing circuit 102 configured to generate an address of the memory for each code datum intended to be written in the memory 11 and not to generate the same address twice in the process of writing the program code.

An exemplary structure of the addressing circuit 102 will be revisited in greater detail below.

The integrated circuit 10 also includes a first encryption/decryption circuit 103, for example circuit executing a symmetric encryption algorithm of AES or DES type, which is configured to perform a first operation of encrypting the address at which the code datum is to be written, using the key, to obtain an encrypted address.

The integrated circuit 10 also includes a second encryption/decryption circuit 104, configured to perform a second operation of encrypting the code datum by using the encrypted address.

As above, exemplary structures of such second encryption/decryption circuit 104 will be described in detail below.

The integrated circuit 10 also includes write circuit 105, which are conventional in structure and known per se, configured to write the encrypted code datum at the corresponding address.

The integrated circuit 10 also includes, in the context of loading the program code into an instruction register 1000 of the processing unit 100, read circuit 106, which are conventional in structure and known per se, configured to read the encrypted program code data 110 contained in the external memory 11.

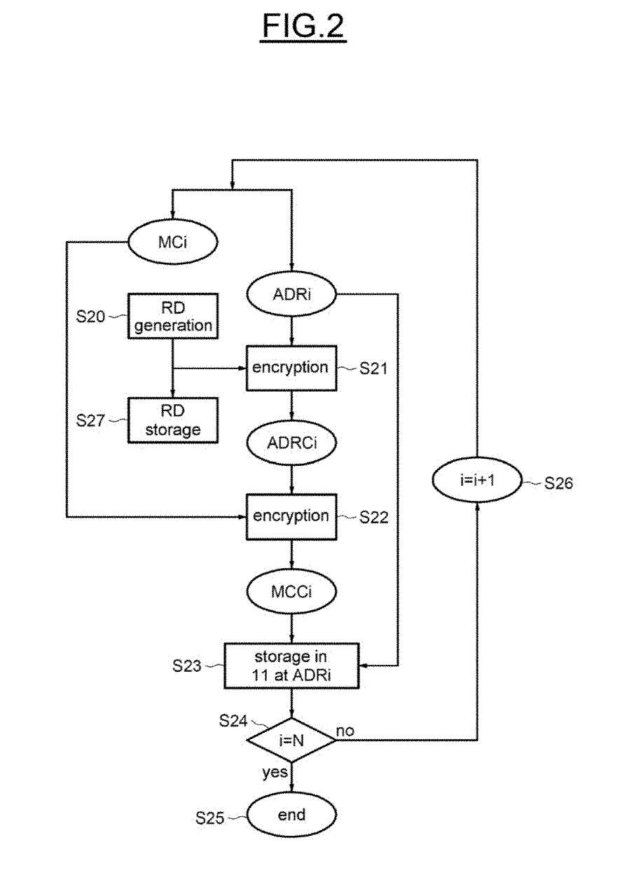

Reference is now more particularly made to FIG. 2 to describe one mode of implementation of a method for encrypting and storing a program code in the external memory 11.

It is assumed here that the code datum 101, which may be a digital word, is to be stored in the external memory at the address ADRi.

In step S20, the generation circuit 101 generates the encryption key RD, for example randomly.

This encryption key RD may advantageously be stored (step S27) in an internal memory 109 (FIG. 1) of the integrated circuit 10, for example a protected read-only memory.

It should be noted that this storage operation may be performed at the start of, during or at the end of the process of writing the program code in the external memory 11.

In a step S21, the first encryption/decryption circuit 103 encrypts the address ADRi using the encryption key RD to provide an encrypted address ADRCi.

Next, in step S22, the second encryption/decryption circuit 104 encrypts the code datum MCi with the encrypted address ADRCi to provide an encrypted code datum MCCi.

The write circuit 105 then writes (step S23) the encrypted datum MCCi in the memory 11 at the address ADRi.

The process described above is reiterated for the next address until the range of addresses provided for storing the program code has been filled (steps S24 and S26).

Conversely, in the case in which the end of the range of addresses, represented in step S24 by the value N for the index i, has been reached, the write process is stopped and any new operation of writing in the external memory 11 using the encryption key RD that was just used is forbidden.

Furthermore, in step S26, moving from the address ADRi to the next address ADRi+1, the next address is generated such that the memory cannot be written twice at the same address.

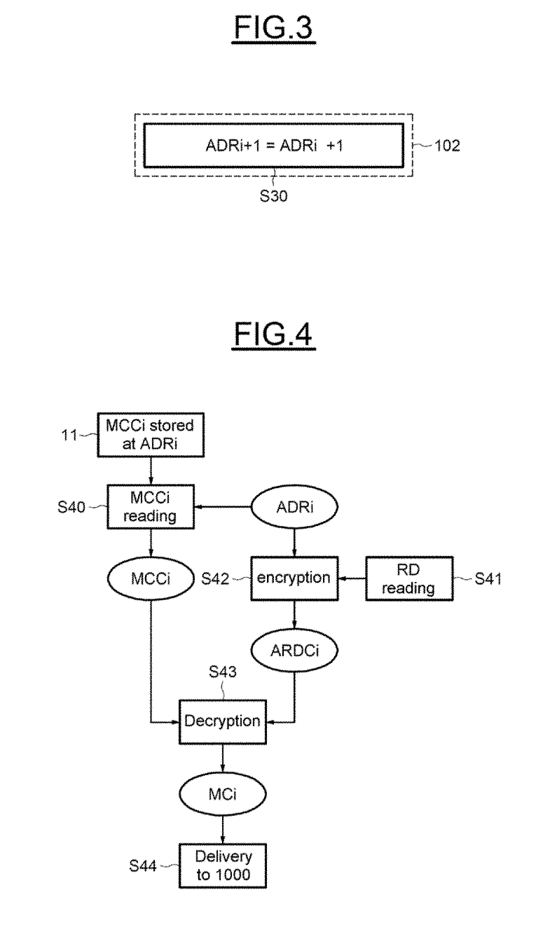

As illustrated in FIG. 3, a particularly simple way of performing this function includes using a hardware counter for the structure of the addressing circuit 102 so that the address ADRi+1 is equal to the address ADRi incremented by 1 for example (step S30). Once the counter has reached its count value corresponding to the end of the range of addresses, the processing unit prevents any new operation of writing in the external memory.

Thus, if a malicious third party attempts to store multiple data in succession at one and the same address in the memory using the encryption process described above, the malicious third party will be unsuccessful since it is not possible to write two successive items of data at the same address, as stated above.

It will therefore be more difficult or even impossible for the malicious third party to attempt to obtain the encryption key.

Reference is now made to FIG. 4 to describe a method for running the program code stored in the external memory 11.

More specifically, for an encrypted code datum MCCi stored at the address ADRi in the memory 11, the read circuit extracts this datum in step S40.

Furthermore, the first encryption circuit 103 encrypts the address ADRi using the encryption key RD extracted in step S41 from the protected memory 109.

The encrypted address ADRCi is then obtained, which is used by the decryption circuit 104 to decrypt S43 the encrypted code datum MCCi so as to deliver the unencrypted code datum MCi.

This code datum is then delivered (step S44) by the second encryption/decryption circuit 104 directly to the instruction register 1000 of the processing unit.

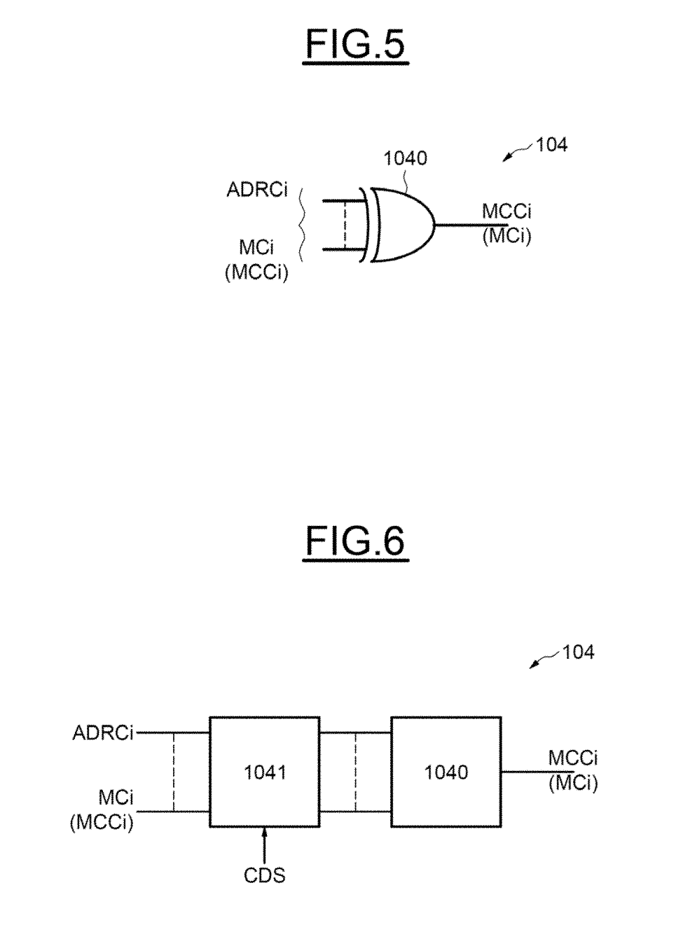

As illustrated in FIG. 5, the second encryption/decryption circuit 104 may include an EXCLUSIVE OR operator 1040 receiving, as input, the bits of each code datum MCi (or of each encrypted code datum MCCi) and the bits of the corresponding encrypted address ADRCi to deliver the encrypted code word MCCi (or the unencrypted code word MCi).

As a variant, it would be possible, as illustrated in FIG. 6, for the second encryption/decryption circuit 104 to include scrambling circuit 1041 configured to modify the inputs of the EXCLUSIVE OR operator 1040 according to a scrambling code CDS.

What is claimed is:

1. A method for writing a set of information for processing by a processing unit of an integrated circuit in an external memory outside the integrated circuit, the method comprising:
generating, within the integrated circuit, an encryption key;
for each item of information intended to be written at an address of the external memory, first encrypting the address within the integrated circuit by a first encryption/decryption circuit using the encryption key to obtain an encrypted address;
second encrypting the item of information within the integrated circuit using a second encryption/decryption circuit using the encrypted address to obtain an encrypted item of information; and
writing the encrypted item of information at the address of the external memory, wherein the external memory is not able to be written twice at a same address during a write process.

2. The method according to claim 1, wherein, during the write process, a first item of information of a plurality of items of information is written at an initial address of the external memory, and wherein the method further comprises incrementing the address after each operation of writing each subsequent item of information of the plurality of items of information.

3. The method according to claim 1, wherein the set of information is to be written in a range of addresses of the external memory, and wherein the method further comprises forbidding any new operation of writing in the external memory in response to a determination that all addresses of the range of addresses have been used in the write process.

4. The method according to claim 1, wherein generating the encryption key comprises randomly generating the encryption key.

5. The method according to claim 1, further comprising generating a new encryption key before each new write process.

6. The method according to claim 1, wherein the processing unit comprises a microcontroller.

7. The method according to claim 1, wherein the set of information comprises a program code to be run by the processing unit.

8. The method according to claim 1, further comprising storing the encryption key in an internal storage inside the integrated circuit.

9. A method for processing a set of information by a processing unit of an integrated circuit, the set of information comprising an encrypted item of information having been written in an external memory outside the integrated circuit, the method comprising:
for each encrypted item of information stored at an address of the external memory and intended to be loaded into the processing unit, first encrypting the address within the integrated circuit by a first encryption/decryption circuit using an encryption key to obtain an encrypted address;
reading the encrypted item of information stored in the external memory at the address;
decrypting the encrypted item of information within the integrated circuit using a second encryption/decryption circuit using the encrypted address to obtain a decrypted item of information; and
loading the decrypted item of information into a register of the processing unit.

10. The method according to Claim 9, wherein the set of information comprises a program code including code data, and wherein the method further comprises running the program code by the processing unit loading each decrypted code datum into an instruction register of the processing unit.

11. A device comprising an integrated circuit and an external memory outside the integrated circuit, the integrated circuit comprising:
a processing unit;
an information input for receiving a set of information intended to be written in the external memory and to be processed by the processing unit;
a generation circuit configured to generate an encryption key;
an addressing circuit configured to generate an address of the external memory for each item of information intended to be written in the external memory and not to generate a same address twice in a process of writing the set of information to the external memory;
a first encryption/decryption circuit configured to perform a first encrypting on the address using the encryption key to obtain an encrypted address;
a second encryption/decryption circuit configured to perform a second encrypting n the item of information using the encrypted address to obtain an encrypted item of information; and
a write circuit configured to write the encrypted item of information at the address of the external memory.

12. The device according to claim 11, wherein, during a write process, the addressing circuit is configured to generate an initial address and to increment the address after each operation of writing an item of information to the external memory.

13. The device according to claim 11, wherein the addressing circuit is configured to write the set of information in a range of addresses of the external memory and to forbid any new addressing in response to a determination that all addresses of the range of addresses have been used in a write process.

14. The device according to claim 11, wherein the generation circuit is configured to generate the encryption key in a random manner.

15. The device according to claim 11, wherein the generation circuit is configured to generate a new encryption key before each new write process.

16. The device according to claim 11, wherein the second encryption/decryption circuit comprises an EXCLUSIVE OR operator.

17. The device according to claim 16, wherein the second encryption/decryption circuit comprises a scrambling circuit configured to modify inputs of the EXCLUSIVE OR operator according to a scrambling code.

18. The device according to claim 11, wherein the processing unit comprises a microcontroller.

19. The device according to claim 11, wherein the set of information comprises a program code comprising code data and intended to be run by the processing unit.

20. The device according to claim 11, wherein the integrated circuit further comprises an internal storage configured to store the encryption key.

21. The device according to claim 20, wherein, in response to the external memory containing encrypted items of information, the first encryption/decryption circuit is configured to extract the encryption key from the internal storage and to encrypt, using the encryption key, each address at which an item of information is to be read, wherein the integrated circuit further comprises a read circuit configured to read, in the external memory at the address, the encrypted item of information, and wherein the second encryption/decryption circuit is configured to decrypt the read encrypted item of information with the encrypted address, and to deliver the decrypted code datum to a register of the processing unit.
